(19) United States
(12) Patent Application Publication
(10) Pub. No.: US 2010/0124481 A1
(43) Pub. Date: May 20, 2010

(54) APPARATUS AND METHOD FOR HANDLING MODULES OF MATERIAL

(76) Inventor: William E. Winn, Levelland, TX (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/508,179

(22) Filed: Jul. 23, 2009

Related U.S. Application Data
(60) Provisional application No. 61/114,581, filed on Nov. 14, 2008.

(51) Int. Cl. B65G 47/252; B65G 13/00

(52) U.S. Cl. 414/806; 414/226.04; 193/35 R

(57) ABSTRACT

An apparatus for handling a module of cotton for being supplied to a machine for processing the cotton includes a support structure configured to support the module above a surface. The support structure includes a first segment, a second segment, and a hinging structure configured to operably couple the first segment and the second segment to one another, such that the first segment and the second segment can pivot with respect to one another. The apparatus also includes an actuator operably coupled to at least one of the first segment and the second segment. The actuator is configured to pivot one of the first segment and the second segment relative to another of the first segment and the second segment, and the apparatus is configured to re-orient the module.

### RELATED APPLICATION

This application claims the benefit of priority under 35 U.S.C. §119(e) of U.S. Provisional Application No. 61/114,581, filed Nov. 14, 2008, the disclosure of which is incorporated herein by reference.

### FIELD OF THE DISCLOSURE

The present disclosure relates to an apparatus and method for handling modules of material. In particular, the present disclosure relates to an apparatus and method for handling modules of material, such as wrapped modules of cotton, for being supplied to a machine for processing the material.

### BACKGROUND

Modules of material may include, for example, material harvested from agricultural crops, such as, for example, straw, hay, and cotton. Such modules of material may take the general form of a cylinder, which are sometimes referred to as “round bales” or “round modules.” For example, harvesting machines may cut or harvest straw, hay, or cotton from crops of the corresponding plants and roll the harvested material into a generally cylindrical module form. The material may also be at least partially wrapped (e.g., on the side but not the ends of the cylinder) with a protective covering in order to hold the module together and/or protect the material constituting the module.

Some modules of material may be large enough to prevent manual handling, such that handling is facilitated with the assistance of one or more machines. Thus, such modules may be difficult to manipulate for transportation and/or further processing. For example, some modules may have a height or length dimension defined between circular ends of the module ranging from about 6 feet to about 10 feet (e.g., about 8 feet) and a side extending between the two ends and defined by a diameter dimension ranging from about 6.5 feet to about 8.5 feet (e.g., about 7.5 feet). Such modules of material may weigh from about 4,000 lbs. to about 6,000 lbs. (e.g., about 5,000 lbs.), depending on, for example, the density of the material constituting the module.

Further, some materials may receive further processing. For example, cotton may be harvested by machines sometimes referred to as “cotton pickers.” Such machines may remove the raw cotton from the cotton plants and form the raw cotton into modules. For example, some modules my generally take the form of large cylinders. Further, some cotton pickers wrap the module in a plastic or protective wrapping, and deposit the module on its side in the field in which the cotton is being harvested. As outlined above, such modules may be large and heavy, and thus, it may be desirable to use a machine, such as a material handler, to transport the modules to a location for processing. For example, modules of cotton may be processed by machines, such as cotton gins, that break up the modules and remove therefrom undesirable debris, such as, for example, sticks, leaves, seeds, seed pods, and/or other debris from the harvesting process.

Some module handlers are vehicles including a fork designed to pick up the cylindrical modules and load the modules onto a feeder bed associated with a processing machine or onto a larger vehicle for transporting the modules to a processing machine. Since some cotton pickers deposit the wrapped modules on their sides rather than on their ends, module handlers are designed to lift the module and carry them in the same orientation, in particular, on their sides rather than on their ends. Thus, when a module is loaded onto the feeder bed support structure of a processing machine, it is typically loaded onto the feeder onto its side rather than on its end. This may render it difficult to remove the wrapping from the module, which may be desirable before the module enters the material processing machine.

Thus, it may be desirable to provide devices and methods to facilitate the handling of modules of material (e.g., large cylindrical modules of cotton material). Further, it may be desirable to provide devices and methods to supply modules to material processing machinery.

### SUMMARY

In the following description, certain aspects and embodiments will become evident. It should be understood that the aspects and embodiments, in their broadest sense, could be practiced without having one or more features of these aspects and embodiments. It should be understood that these aspects and embodiments are merely exemplary.

One aspect of the disclosure relates to an apparatus for handling a module of material, such as a round, wrapped module of cotton material, for being supplied to a machine for processing the material includes a support structure configured to support the module above a surface. The support structure includes a first segment, a second segment, and a hinging structure configured to operably couple the first segment and the second segment to one another, such that the first segment and the second segment can pivot with respect to one another. The apparatus also includes an actuator operably coupled to at least one of the first segment and the second segment. The actuator is configured to pivot one of the first segment and the second segment relative to another of the first segment and the second segment, and the apparatus is configured to re-orient the module. The apparatus may include a controller in communication with the actuator that causes re-orientation of the module to facilitate removal of a wrapper or protective covering of the module prior to processing of the module by one or more machines.

According to another aspect, a system for handling and processing a module of material includes an apparatus for handling the module of material and supplying a machine configured to process the material. The apparatus includes a support structure configured to support the module above a surface and facilitate movement of the module toward the machine. The support structure includes a first segment, a second segment, and a hinging structure configured to operably couple the first segment and the second segment to one another, such that the first segment and the second segment can pivot with respect to one another. The apparatus further includes an actuator operably coupled to at least one of the first segment and the second segment. The actuator is configured to pivot one of the first segment and the second segment relative to another of the first segment and the second segment. The apparatus is configured to re-orient the module. The system also includes a machine configured to process the material.

According to still a further aspect, a method for handling a module of material defining two ends and at least one side extending between the two ends, includes placing the module of material on a support structure such that the module of material is resting on the at least one side. The method further includes raising a first portion of the support structure such that the module of material is re-oriented such that the module of material is resting on one of the two ends on a second portion of the support structure. The method also includes moving the module of material toward a machine for processing the material.

Additional aspects and/or advantages of the disclosure will be set forth in part in the description which follows, and in part will be obvious from the description, or may be learned by practice of the disclosed embodiments.

Aside from the structural and procedural arrangements set forth above, the embodiments could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this description, illustrate several exemplary embodiments and together with the description, serve to explain principles of the embodiments. In the drawings,

FIG. 1 is a schematic elevation view of an exemplary embodiment of an apparatus for handling material with an exemplary module in a first position and condition;

FIG. 2 is a schematic elevation view of the exemplary embodiment of apparatus shown in FIG. 1 with the exemplary module in a second condition;

FIG. 3 is a schematic elevation view of the exemplary embodiment of apparatus shown in FIG. 1 in a second configuration;

FIG. 4 is a schematic elevation view of the exemplary embodiment of apparatus shown in FIG. 1 with the exemplary module in a second position; and

FIG. 5 is a schematic elevation view of the exemplary embodiment of apparatus shown in FIG. 1 with the exemplary module entering an exemplary material processing machine.

### DESCRIPTION OF EXEMPLARY EMBODIMENTS

Reference will now be made in detail to exemplary embodiments. Wherever possible, the same reference numbers are used in the drawings and the description to refer to the same or like parts.

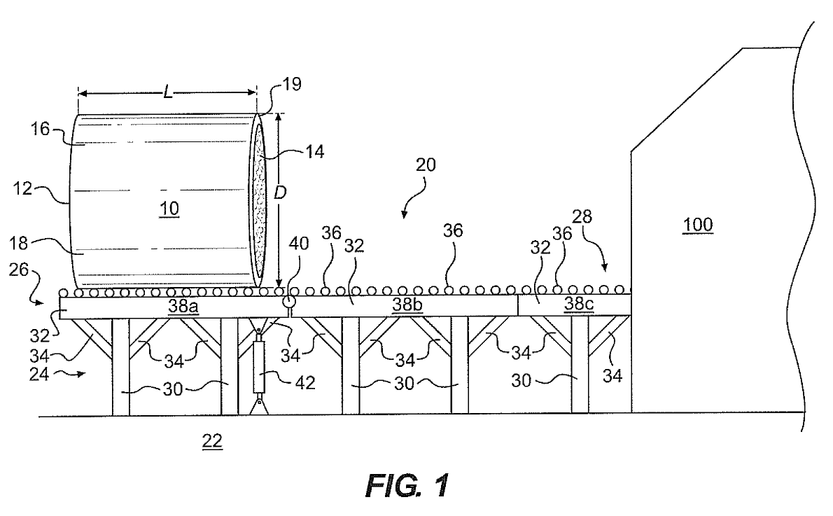

Referring to FIG. 1, a material, such as, for example, cotton, is formed into an exemplary module 10 defining a generally cylindrical shape defined by two opposing ends 12 and 14 having a generally circular shape, and a side 16 defined by a cylindrical surface extending between two ends 12 and 14. Side 16 defines a length L extending between ends 12 and 14, and ends 12 and 14 may have a diameter D defining the circular-shaped ends. For example, length L may range from about 6 feet to about 10 feet (e.g., about 8 feet), and diameter D may range from about 6.5 feet to about 8.5 feet (e.g., about 7.5 feet). Exemplary module 10 is at least partially covered with a wrapping 18, which maintains the material constituting module 10 in a cylindrical form and/or serves to protect the material of module 10. For example, exemplary wrapping 18 covers side 16 but does not completely cover ends 12 and 14 of exemplary module 10. As shown in FIG. 1, wrapping 18 extends around an edge 19 between side 16 and ends 12 and 14, but does not extend completely across ends 12 and 14. Rather, wrapping 18 may extend, for example, only about several inches from edge 19 toward a center of sides 12 and 14. Exemplar wrapping 18 may include plastic and/or other materials that serve to maintain module 10 in cylindrical form and/or protect the material constituting module 10.

Such exemplary modules of material may, depending on the type of material constituting module 10, weigh from about 4,000 lbs. to about 6,000 lbs. (e.g., about 5,000 lbs.), for example, if module 10 comprises (e.g., harvested cotton). Such a module 10 may be the supplied by, for example, a cotton picker (not shown) (or a cotton stripper equipped with a round baler (not shown)) designed to pick cotton from cotton plants, roll the picked cotton into a cylindrical form, and cover at least a portion of the cylindrical form of cotton (e.g., the cylindrical side but not the opposing ends) with a wrapping of plastic and/or other material, which maintains the cotton in a generally cylindrical form and/or protects the cotton. Although exemplary module 10 is a cylindrical-shaped module of cotton having the exemplary dimensions outlined above, modules of other shapes and sizes, modules not covered with wrapping, and/or modules containing other materials, are contemplated.

As shown in FIG. 1, exemplary module 10 may be loaded onto an exemplary apparatus 20 for handling modules of material and/or for facilitating the supply of modules 10 to a material processing machine, such as exemplary processing machine 100. Apparatus 20 may be supported on a surface 22, such as the floor of a material processing facility. Exemplary processing machine 100 may be, for example, a module feeder or cotton gin for breaking up modules 10 of cotton and/or for removing therefrom undesirable debris, such as, for example, sticks, leaves, seeds, seed pods, and/or other debris in the cotton resulting from the cotton harvesting process. For example, exemplary processing machine 100 may be a machine at least similar to machines disclosed in U.S. Pat. No. 6,038,741, U.S. Pat. No. 6,557,213, and U.S. Pat. No. 6,786,438, the disclosures of which are incorporated herein by reference.

As shown, exemplary apparatus 20 includes a support structure 24 for supporting module 10 and facilitating conveyance of module 10 from a first end 26 of apparatus 20 to a second end 28 of apparatus 20 adjacent material processing machine 100. Support structure 24 may include two rows of a plurality of substantially upstanding supports 30 (e.g., vertical supports) extending between surface 22 and corresponding rows of one or more cross members 32. (FIGS. 1-5 show elevation views of exemplary apparatus 20, and thus, only a single row of upstanding supports 30 and a corresponding single row of cross members 32 is shown in the figures.) Exemplary support structure 24 may include braces 34 extending obliquely between upstanding supports 30 and cross member(s) 32, thereby providing additional support and/or rigidity to apparatus 20. Support structure 24 may be formed of metal, such as, for example, one or more of steel and aluminum, and/or any other materials having sufficient strength and other characteristics for performing the exemplary functions described herein.

As shown in the figures, exemplary apparatus 20 includes a plurality of rollers 36 extending between the two rows of cross members 32. Rollers 36 are configured to rotate, for example, as module 10 moves from first end 26 of apparatus 20 to second end 28 of apparatus 20, to facilitate movement of module 10 into exemplary processing machine 100. According to some embodiments, one or more of rollers 36 may be motorized to force module 10 to move along support structure 24. It is contemplated that other structures known to those skilled in the art that serve the function of rollers 36 may be used, such as, for example, one or more belts (e.g., motorized belts).

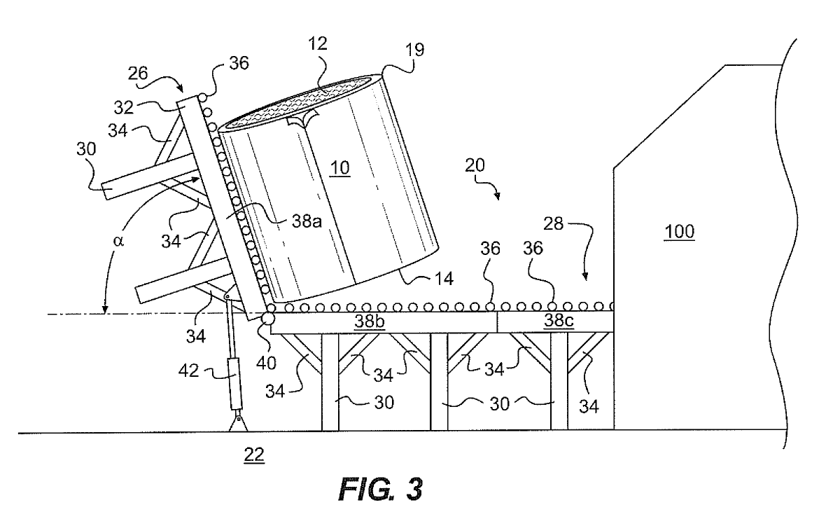

According to the exemplary embodiment shown in the figures, support structure 24 includes three segments 38a, 38b, and 38c. Segment 38a is hingedly coupled to segment 38b via a hinging structure 40. Hinging structure 40 may be any known type of hinge that permits relative pivoting between segment 38a and segment 38b (see FIG. 3). Although the exemplary embodiment shown in FIGS. 1-5 includes segment 38a positioned behind and aligned with segment 38b and/or segment 38c, it is contemplated that segment 38a may be positioned next to segment 38b and/or segment 38c, for example, with hinging structure 40 extending along cross members 32 between segment 38a and segment 38b and/or segment 38c, such that segment 38a is configured to tilt-up about its cross member 32 via hinging structure 40.

Exemplary apparatus 20 further includes at least one actuator 42 (e.g., two actuators, one associated with each row of cross member(s) 32) configured to pivot segment 38a relative to segment 38b, such that first end 26 raises up relative to hinging structure 40. For example, actuator(s) 42 may include one or more air cylinders, hydraulic cylinders, and/or hoists (not shown). Other actuators(s) known to those skilled in the art for pivoting segment 38a are also contemplated. Further, it is contemplated that actuator(s) 42 may be located in different positions relative to segment 38a and/or hinging structure 40, for example, to provide a mechanical advantage or packaging that takes into account space availability or other considerations. For example, one end of actuator 42 may be operably coupled to upstanding support 30 of segment 38b rather than surface 22, and/or another end of actuator 42 may be operably coupled to one of braces 34 rather than cross member 32 of segment 38a.

Some embodiments may include a controller (not shown) in communication with actuator 42. The controller may be configured to cause actuator 42 to re-orient module 10 to facilitate removal wrapping 18 from module 10. For example, the controller may include an interface for manipulation by an operator. For example, the interface may include one or more of an operator panel associated with apparatus 20 and/or processing machine 100, a hand-held remote control device, and a central control device or panel associated with a facility in which exemplary apparatus 20 and processing machine 100 are located.

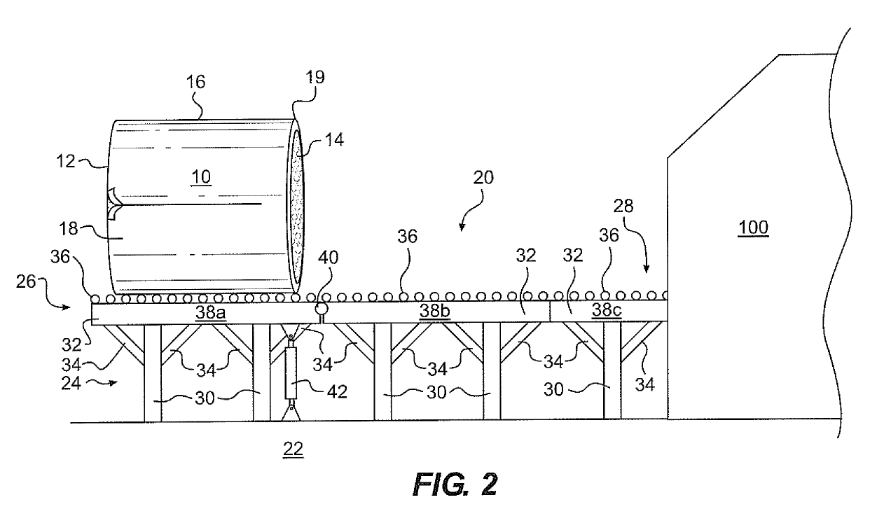

Referring to FIGS. 1-5, during exemplary use of apparatus 20, a module of material, such as exemplary module 10, is placed on apparatus 20. Such a module may be, for example, a cylindrical-shaped module of cotton formed via a cotton picker (not shown) and placed on apparatus 20 via a material handier (not shown), such that module 10 rests on its side 16 (see FIG. 1) on first end 26 of apparatus 20. Exemplary module 10 includes a wrapping 18, and, as shown in FIG. 2, wrapping 18 may be sliced manually (e.g., via a knife) or via an automated cutter (not shown). For example, by virtue of module 10 being oriented on its side 16 rather than on one of ends 12 or 14, wrapper 18 may be more easily sliced manually via a knife.

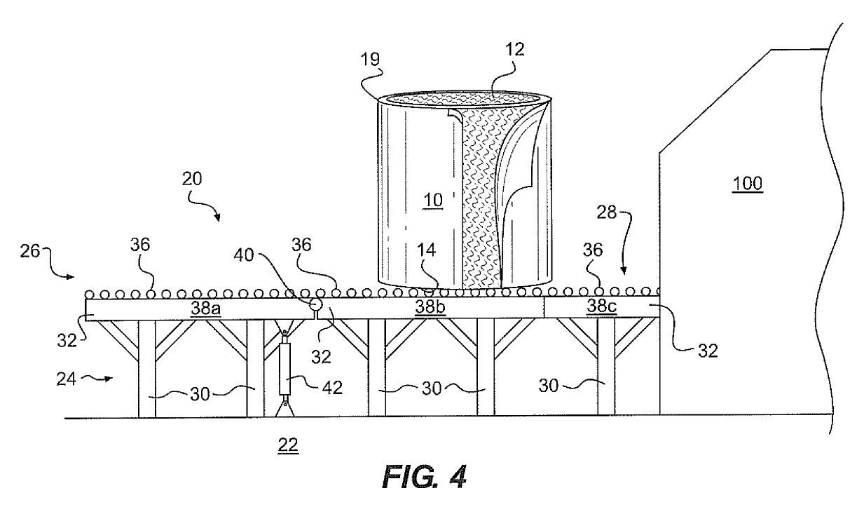

Referring to FIG. 3, exemplary actuator(s) 42 may be extended, such that segment 38a pivots relative to segment 38b. For example, actuator(s) 42 and/or segment 38a may be configured in response to inputs or signals from a controller to pivot through an angle a ranging from about 45 degrees to about 90 degrees (e.g., 70 degrees), or an amount sufficient to result in re-orienting module 10, such that it rests on end 14 on, for example, segment 38b, rather than on its side 16 (see also FIG. 4).

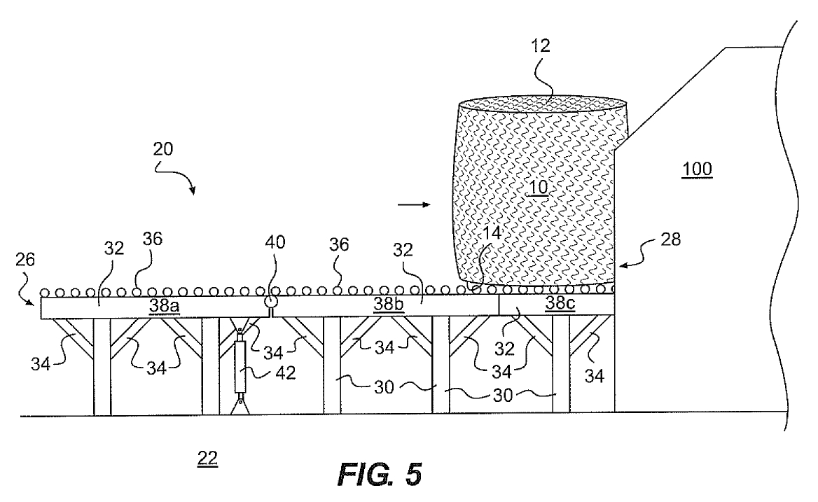

Referring to FIG. 4, after module 10 has been re-oriented to rest on end 14, segment 38a may be lowered to the position shown in FIGS. 1 and 2. Module 10, now resting on segment 38b and/or segment 38c, is in a position to facilitate removal of wrapping 18. As outlined previously herein, exemplary wrapping 18, although extending from side 16 and around the edges of ends 12 and 14, does not completely cover ends 12 and/or 14. Thus, exemplary wrapping 18, already sliced, may be pulled off of module 10, since module 10 is not resting on a significant portion of wrapping 18. As shown in FIG. 5, module 10, with its wrapping 18 removed, is ready to be moved to second end 28 of apparatus 20 and into exemplary material processing machine 100 when appropriate for processing.

According to some embodiments, one or more of the above-referenced exemplary processes may be at least partially automated. For example, apparatus 20 may be provided with a number of sensors to detect the presence of a module at various locations along the length of apparatus 20. For example, a sensor may be provided to detect the presence of module 10 on segment 38a. Upon such detection, an automated cutter may be activated to slice wrapping 18. Upon termination of automated cutter's activation, a solenoid may be activated, thereby extending actuator(s) 42, such that segment 38a is pivoted relative to segment 38b. A sensor associated with segment 38b may be provided to detect the presence of module 10, thereby activating a device for removing wrapping 18. Upon termination of activation of the device, module 10 may be moved into position to enter material processing machine 100 via, for example, a motor-driven belt.

At least some portions of exemplary embodiments of the systems outlined above may used in association with portions of other exemplary embodiments. Moreover, at least some of the exemplary embodiments disclosed herein may be used independently from one another and/or in combination with one another and may have applications not disclosed herein.

It will be apparent to those skilled in the art that various modifications and variations can be made to the structures and methodologies described herein. Thus, it should be understood that the invention is not limited to the subject matter discussed in the description. Rather, the present invention is intended to cover modifications and variations.

What is claimed is:

1. An apparatus for handling a module of cotton for being supplied to a machine for processing cotton, the apparatus comprising:
a support structure configured to support the module above a surface, the support structure comprising
a first segment,
a second segment, and
a hinging structure configured to operably couple the first segment and the second segment to one another, such that the first segment and the second segment can pivot with respect to one another; and
an actuator operably coupled to at least one of the first segment and the second segment, the actuator being configured to pivot one of the first segment and the second segment relative to another of the first segment and the second segment,
wherein the apparatus is configured to re-orient the module.

2. The apparatus of claim 1, wherein the actuator defines two ends, and one end of the actuator is operably coupled to the first segment, and a second end of the actuator is configured to be operably coupled to the surface.

3. The apparatus of claim 1, wherein the actuator defines two ends, and one end of the actuator is operably coupled to the first segment, and a second end of the actuator is operably coupled to a portion associated with the second segment.

4. The apparatus of claim 1, wherein the actuator comprises at least one of an air cylinder, a hydraulic cylinder, and a hoist.

5. The apparatus of claim 1, wherein the support structure further comprises a plurality of rollers configured to facilitate movement of the module from one end of the apparatus to another end of the apparatus.

6. The apparatus of claim 1, wherein the support structure comprises at least one cross member configured to support the module, and a plurality of upstanding members configured to space the at least one cross member above the surface.

7. The apparatus of claim 1, wherein the module defines two ends and at least one side extending between the two ends, and wherein the apparatus is configured to re-orient the module such that the module is re-oriented from being supported on the at least one side to being supported on one of the two ends.

8. An apparatus for handling a wrapped module of cotton for being supplied to a cotton processing machine, the apparatus comprising:
a feeder bed support structure configured to support the module above a surface, the feeder bed support structure comprising
a first segment,
a second segment, and
a hinging structure configured to operably couple the first segment and the second segment to one another, such that the first segment and the second segment can pivot with respect to one another;
an actuator operably coupled to at least one of the first segment and the second segment, the actuator being configured to pivot one of the first segment and the second segment relative to another of the first segment and the second segment; and
a controller in communication with the actuator, the controller being configured to cause the actuator to re-orient the module supported on the feeder bed support structure to facilitate removal of wrapping on the module prior to supplying the module to the cotton processing machine.

9. The apparatus of claim 8, wherein the actuator defines two ends, and one end of the actuator is operably coupled to the first segment, and a second end of the actuator is configured to be operably coupled to the surface.

10. The apparatus of claim 8, wherein the actuator defines two ends, and one end of the actuator is operably coupled to the first segment, and a second end of the actuator is operably coupled to a portion associated with the second segment.

11. The apparatus of claim 8, wherein the actuator comprises at least one of an air cylinder, a hydraulic cylinder, and a hoist.

12. The apparatus of claim 8, wherein the feeder bed support structure further comprises a plurality of rollers configured to facilitate movement of the module from one end of the apparatus to another end of the apparatus.

13. The apparatus of claim 8, wherein the feeder bed support structure comprises at least one cross member configured to support the module, and a plurality of upstanding members configured to space the at least one cross member above the surface.

14. The apparatus of claim 8, wherein the module defines two ends and at least one side extending between the two ends, and wherein the apparatus is configured to re-orient the module such that the module is re-oriented from being supported on the at least one side to being supported on one of the two ends.

15. The apparatus of claim 8, wherein the cotton processing machine is configured to at least one of break up the module and remove debris from the cotton.

16. The apparatus of claim 8, wherein the cotton processing machine comprises a cotton gin.

17. A method for handling a module of material defining two ends and at least one side extending between the two ends, the method comprising:
placing the module of material on a support structure such that the module of material is resting on the at least one side;
raising a first portion of the support structure such that the module of material is re-oriented such that the module of material is resting on one of the two ends on a second portion of the support structure; and
moving the module of material toward a machine for processing the material.

18. The method of claim 17, wherein the module of material is partially covered with a wrapping, and the method further comprises cutting the wrapping while the module of material is resting on the at least one side.

19. The method of claim 18, wherein the method further comprises removing the wrapping while the module of material is resting on the one end.

20. The method of claim 17, wherein the module of material is cylindrical-shaped, with the at least one side comprising a cylindrical surface extending between the two ends, and wherein the module of material is partially covered with a wrapping, and the method further comprises cutting the wrapping.
